(19) United States
(12) Patent Application Publication
(10) Pub. No.: US 2026/0318267 A1
(43) Pub. Date: Oct. 15, 2026

(54) EXHAUST GAS RECIRCULATION SYSTEM

(71) Applicant: GM GLOBAL TECHNOLOGY OPERATIONS LLC, Detroit, MI (US)

(72) Inventor: Eric Darvin THOMAS, Shelby Township, MI (US)

(21) Appl. No.: 19/179,811

(22) Filed: Apr. 15, 2025

(51) Int. Cl. F02M 26/07; F01N 3/10; F01N 3/20; F02B 29/04; F02B 37/22; F02D 41/00; F02M 26/14

(52) U.S. Cl. CPC F02M 26/07; F01N 3/106; F01N 3/2006; F01N 3/2066; F02B 29/0406; F02B 37/22; F02D 41/0077; F02M 26/14

(57) ABSTRACT

An exhaust gas recirculation (EGR) system for an engine including: a throttle valve along an intake conduit configured to regulate flow of air from a compressor to the engine; an engine exhaust conduit extending from the engine to a turbine; a turbine exhaust conduit extending from the turbine to an exhaust outlet; an oxidation catalyst along the turbine exhaust conduit; a low-pressure EGR (LP-EGR) conduit extending from the turbine exhaust conduit downstream of the oxidation catalyst, and extending to the intake conduit downstream of both the compressor and the throttle valve; an LP-EGR valve configured to regulate exhaust flow from the turbine exhaust conduit into the LP-EGR conduit; and a controller configured to open the LP-EGR valve when the engine is at idle to recirculate exhaust from the turbine through each of the engine, the turbine, and the oxidation catalyst to activate the oxidation catalyst.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to an exhaust gas recirculation system.

Exhaust gas recirculation (EGR) systems are used to control emissions from an engine, such as a diesel engine. EGR systems recirculate a portion of the exhaust gases back into the engine's intake air. This process dilutes the oxygen concentration of the incoming air, which lowers the temperature of the air-fuel mixture combustion reactions inside the engine cylinders. By reducing these temperatures, the formation of nitrogen oxides (NOx) is decreased.

### SUMMARY

The present disclosure provides for, in various features, an exhaust gas recirculation (EGR) system for an engine including: a turbocharger including a compressor and a turbine; an intake conduit extending from the compressor to the engine; a throttle valve along the intake conduit configured to regulate flow of air from the compressor to the engine; an engine exhaust conduit extending from the engine to the turbine; a turbine exhaust conduit extending from the turbine to an exhaust outlet; an oxidation catalyst along the turbine exhaust conduit; a low-pressure EGR conduit extending from the turbine exhaust conduit downstream of the oxidation catalyst, and extending to the intake conduit downstream of both the compressor and the throttle valve with respect to a direction of airflow through the intake conduit; a low-pressure EGR valve configured to regulate exhaust flow from the turbine exhaust conduit into the low-pressure EGR conduit; and a controller configured to open the low-pressure EGR valve when the engine is at idle to recirculate exhaust from the turbine through each of the engine, the turbine, and the oxidation catalyst to heat and activate the oxidation catalyst.

In further features, the engine is a diesel engine.

In further features, the present disclosure further includes a selective catalytic reduction catalyst and a diesel particulate filter downstream of the oxidation catalyst and upstream of the low-pressure EGR valve with respect to exhaust flow from the turbine exhaust conduit, and a urea injection point between the oxidation catalyst and the selective catalytic reduction catalyst; the controller is configured to open the low-pressure EGR valve when the engine is at idle to recirculate exhaust from the turbine through the selective catalytic reduction catalyst and the diesel particulate filter.

In further features, a charge air cooler is along the intake conduit upstream of the throttle valve.

In further features, the oxidation catalyst is configured to be engine-mounted within an engine compartment.

In further features, the turbine includes restricting vanes movable to regulate flow of exhaust through the turbine; and the controller is configured to control the restricting vanes and substantially close the restricting vanes to increase pressure and temperature of exhaust within the turbine and heat a housing of the turbine.

In further features, a high-pressure EGR conduit in fluid communication with the engine exhaust conduit upstream of the turbine, the high-pressure EGR conduit extending to the intake conduit downstream of the compressor and the throttle valve; and a high-pressure EGR valve configured to regulate exhaust flow from the engine into the high-pressure EGR conduit.

In further features, the low-pressure EGR conduit merges with the high-pressure EGR conduit.

In further features, the controller is configured to: close the high-pressure EGR valve when the low-pressure EGR valve is open; and open the high-pressure EGR valve and close the low-pressure EGR valve after activation of the oxidation catalyst.

In further features, the high-pressure EGR conduit includes an EGR cooler and an EGR cooler bypass valve.

In further features, the controller is configured to open the low-pressure EGR valve and close a high-pressure EGR valve when the engine is operating at up to one-third of maximum torque to recirculate exhaust from the turbine through the engine, the turbine, and the oxidation catalyst.

The present disclosure also provides for, in various features, an exhaust gas recirculation (EGR) system for a diesel engine including: a turbocharger including a compressor and a turbine; an intake conduit extending from the compressor to the diesel engine; a throttle valve along the intake conduit configured to regulate flow of air from the compressor to the diesel engine; an engine exhaust conduit extending from the diesel engine to the turbine; a turbine exhaust conduit extending from the turbine to an exhaust outlet; an oxidation catalyst along the turbine exhaust conduit; a low-pressure EGR conduit extending from the turbine exhaust conduit downstream of the oxidation catalyst, and extending to the intake conduit downstream of both the compressor and the throttle valve with respect to a direction of airflow through the intake conduit; a low-pressure EGR valve configured to regulate exhaust flow from the turbine exhaust conduit into the low-pressure EGR conduit; a high-pressure EGR conduit in fluid communication with the engine exhaust conduit upstream of the turbine, the high-pressure EGR conduit extending to the intake conduit downstream of the compressor and the throttle valve; and a high-pressure EGR valve configured to regulate exhaust flow from the diesel engine into the high-pressure EGR conduit. A controller is configured to: open the low-pressure EGR valve and close the high-pressure EGR valve when the diesel engine is at idle to recirculate exhaust from the turbine through each of the diesel engine, the turbine, and the oxidation catalyst to heat and activate the oxidation catalyst; and close the low-pressure EGR valve and open the high-pressure EGR valve after activation of the oxidation catalyst and in response to increased load on the diesel engine above idle.

In further features, the turbine includes restricting vanes movable to regulate flow of exhaust through the turbine, and the controller is configured to control the restricting vanes and substantially close the restricting vanes to increase pressure and temperature of exhaust within the turbine and heat a housing of the turbine.

In further features, the controller is configured to open the low-pressure EGR valve and close a high-pressure EGR valve when the diesel engine is operating at up to one-third of maximum torque to recirculate exhaust from the turbine through the diesel engine, the turbine, and the oxidation catalyst.

The present disclosure also provides for, in various features, an exhaust gas recirculation (EGR) method for a diesel engine including, with the diesel engine at idle, and prior to a catalyst reaching an activation temperature: opening, in response to a first control signal received from a controller, a low-pressure EGR valve configured to regulate exhaust flow from a turbine exhaust conduit of a turbine into a low-pressure EGR conduit extending from the turbine exhaust conduit downstream of the catalyst to an intake conduit downstream of both a compressor and a throttle valve with respect to a direction of airflow through the intake conduit; and closing, in response to a second control signal received from the controller, a high-pressure EGR valve configured to regulate exhaust flow from the diesel engine into a high-pressure EGR conduit that is in fluid communication with an engine exhaust conduit upstream of the turbine, the high-pressure EGR conduit extending to the intake conduit downstream of the compressor and the throttle valve. Subsequent to the catalyst reaching an activation temperature and in response to increased load on the diesel engine above idle, the method further includes: closing the low-pressure EGR valve in response to a third control signal received from the controller, and opening the high-pressure EGR valve in response to a fourth control signal received from the controller.

In further features, in response to instructions from the controller, the method includes opening the low-pressure EGR valve and closing the high-pressure EGR valve when the diesel engine is operating at up to one-third of maximum torque to recirculate exhaust from the turbine through the diesel engine, the turbine, and the catalyst.

In further features, in response to instructions from the controller, the method includes substantially closing restricting vanes of the turbine to increase pressure and temperature of exhaust within the turbine and heat a housing of the turbine.

In further features, the method includes, in response to an additional control signal from the controller, actuating an EGR cooler bypass valve to direct exhaust gas through an EGR cooler when the high-pressure EGR valve is open in response to the diesel engine operating an increased load above idle.

In further features, the catalyst is an oxidation catalyst, the method further including injecting urea into the low-pressure EGR conduit downstream of the oxidation catalyst.

In further features, the catalyst includes an oxidation catalyst and a selective catalytic reduction catalyst, and a diesel particulate filter is included downstream of the selective catalytic reduction catalyst.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of an exemplary vehicle including an exhaust gas recirculation (EGR) system in accordance with the present disclosure;

FIG. 2 illustrates an exemplary EGR system in accordance with the present disclosure;

FIG. 3 illustrates an additional EGR system in accordance with the present disclosure; and

FIG. 4 illustrates another EGR system in accordance with the present disclosure.

In the drawings, reference numbers may be reused to identify similar and/or identical elements.

### DETAILED DESCRIPTION

The present disclosure generally provides for an exhaust gas recirculation (EGR) system for a diesel engine. The EGR system includes a low pressure (LP) EGR conduit extending from downstream of an oxidation catalyst to a point on an engine intake manifold downstream of a fresh air inlet throttle valve. Exhaust is directed through the LP-EGR conduit when the engine is operating at low loads, such as at idle, to reduce the amount of time needed to warm the oxidation catalyst above its activation temperature, which reduces emissions.

The LP-EGR conduit is a “short route” EGR conduit, through which low-pressure, recirculated exhaust gas that has passed across the oxidation catalyst flows along a relatively shorter path to an area of the engine intake manifold just after the air inlet throttle valve. The “short route” EGR conduct does not recirculate exhaust through the compressor or a charge air cooler. This “short route” EGR conduit differs from a “long route” EGR conduit, which does recirculate exhaust through the compressor and the charge air cooler. The “short route” EGR system of the present disclosure reduces oxidation catalyst activation time at idle during a cold start (such as when engine metal and coolant are near ambient temperature, which may be any temperature below, for example, 50 °C), reduces packaging requirements, supports full range operation of a high-pressure (HP) EGR system for high-load emissions compliance, reduces hardware costs, reduces complexity of diagnostic components, etc.

A controller of the EGR system is configured to direct exhaust gas through the “short route” LP-EGR conduit of the present disclosure at low engine loads and/or engine temperatures at which a primary high-pressure (HP) EGR path may not adequately heat the oxidation catalyst. To direct exhaust gas through the “short route” LP-EGR conduit, the controller is configured to open a LP-EGR control valve, and simultaneously close a HP-EGR control valve leading to the HP-EGR path so as to not decrease flow to the turbine 124. As a result, added exhaust port flow is directed across the turbine and the oxidation catalyst to warm both a housing of the turbine and the oxidation catalyst in relatively less time as compared to without the “short route” LP-EGR conduit.

To further increase the temperature of exhaust flowing to the turbo housing and the oxidation catalyst, when the “short route” LP-EGR conduit is active the controller is configured to control positioning of turbine variable nozzle vanes to be more restrictive. With the turbine variable nozzle vanes substantially closed, exhaust manifold pressure can approach or even exceed in-cylinder pressure late in the power stroke at the time of exhaust valve opening. As a result, a gas expansion temperature drop is relocated to across vanes of the turbine rather than across engine exhaust valves. This further increases exhaust gas temperature traversing from the ports to the turbine, thereby providing hotter exhaust gas for urgently needed warmup of the metallic turbo housing before the oxidation catalyst is activated.

The increase in cylinder pressure during exhaust strokes increases pumping work of a piston during the piston exhaust stroke, which may reduce torque. The torque loss may be offset by slightly higher fuel consumption, which will be acceptable to assure clean combustion at idle in cold ambient conditions (e.g., below freezing ambient temperatures). The “short route” LP-EGR system of the present disclosure can variably decrease such pumping work loss once the oxidation catalyst has reached its activation temperature by reopening the turbine variable nozzle vanes in response to a command from the controller.

With the diesel engine operating under its lowest loads, such as idling at park, maximizing the exhaust manifold pressure has the additional benefit of increased trapped exhaust residual during the intake stroke, particularly for engines with a relatively low piston compression ratio to support higher peak power capability when highly boosted. This results from increased trapped exhaust gas residual mass remaining in the cylinder chambers while their respective pistons are up, and their respective exhaust valves are closed before lift of intake valves during intake strokes, thereby increasing the charge temperature at the beginning of the compression stroke. Upon initial idle after cold start with initially cold chamber surfaces, such hot exhaust gas residual decreases the amount of cold air entering each chamber, mixing with and thereby elevating the subsequent compression temperature above the necessary 580 °C fuel/air compression ignition threshold. This can improve idle stability and decrease emissions after starting a cold engine, such as by way of a remote engine start.

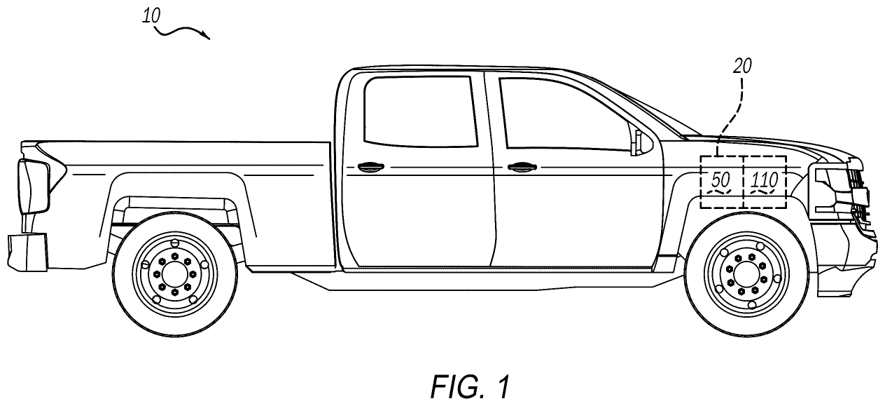

FIG. 1 illustrates an example of a vehicle 10 including an engine compartment 20. Within the engine compartment 20 is an engine 50 and an exhaust gas recirculation (EGR) system 110 in accordance with the present disclosure. The vehicle 10 may be any suitable vehicle, such as a pickup truck as illustrated. The engine 50 is any suitable diesel engine, such as a V8 diesel engine, a straight-six diesel engine, a straight-four diesel engine, etc., for example. The engine 50 may alternatively be configured for any suitable non-automotive use. Exemplary non-automotive applications include, but are not limited to, generators, construction equipment, locomotives, watercraft, etc.

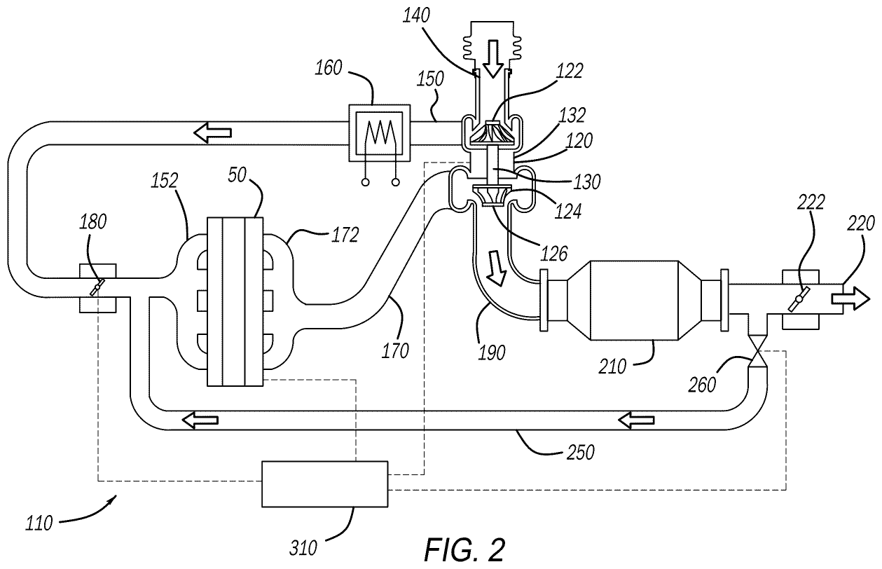

With continued reference to FIG. 1, and additional reference to FIG. 2, the EGR system 110 includes a turbocharger 120. The turbocharger 120 may be any suitable turbocharger, such as a variable geometry turbocharger, for example. In the example illustrated, the turbocharger includes a compressor 122 and a turbine 124 connected by a shaft 130. The turbine 124 is associated with restricting vanes 126, which may be opened and closed to varying degrees to control exhaust flow through the turbocharger 120, as described herein. The compressor 122, the turbine 124, and the shaft 130 are within a housing 132. The housing 132 is made of any suitable metallic material, which is typically quite cold at engine start.

Fresh air enters the compressor 122 through a fresh air inlet 140. An intake conduit 150 extends from the compressor 122 to the engine 50. At the engine 50, the intake conduit 150 includes an engine intake manifold 152. Along the intake conduit 150 upstream of the engine intake manifold 152 (with respect to a direction of airflow from the compressor 122) is a charge air cooler 160. The charge air cooler 160 may be any suitable cooling device configured to cool airflow from the compressor 122. Between the charge air cooler 160 and the engine intake manifold 152 is a throttle valve 180. The throttle valve 180 may be any suitable airflow control device configured to control airflow into the engine 50.

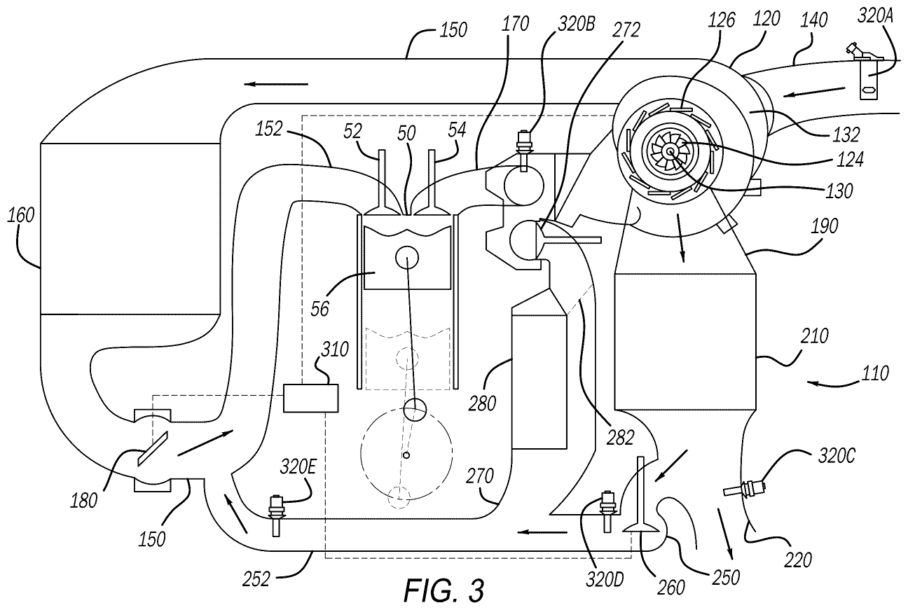

An engine exhaust conduit 170 extends from the engine 50 to the turbine 124. The engine exhaust conduit 170 includes an engine exhaust manifold 172 at the engine 50. Engine intake valves (such as an engine intake valve 52 of FIG. 3) regulate flow of fresh air (as well as a mixture of fresh air and recirculated exhaust gas) into the engine 50. Engine exhaust valves (such as an exhaust valve 54 of FIG. 3) regulate flow of exhaust out of the engine 50 and into the engine exhaust conduit 170. The engine exhaust valves thus also regulate flow of exhaust gas into the housing 132 of the turbocharger 120 and to the turbine 124.

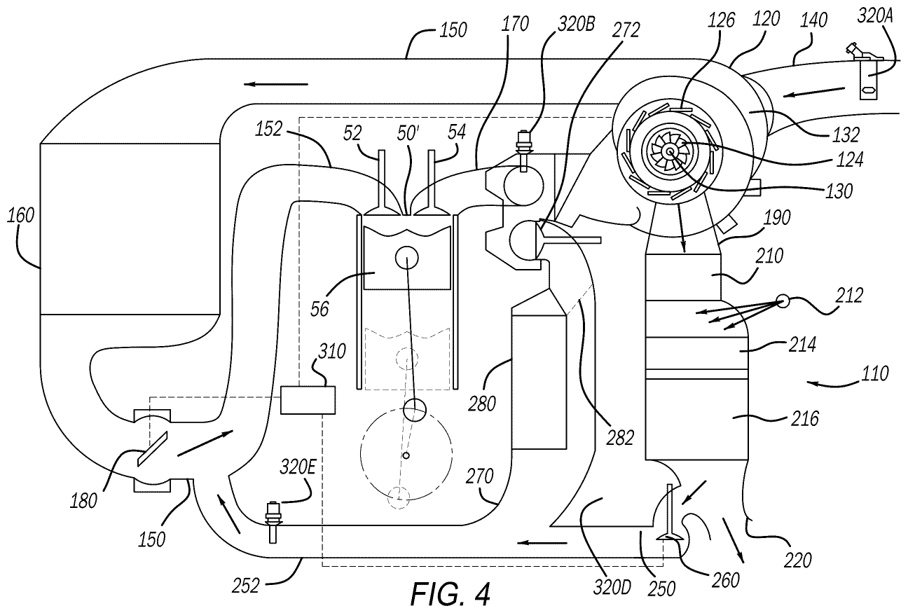

A turbine exhaust conduit 190 extends from the turbine 124 to an exhaust outlet 220. Along the turbine exhaust conduit 190 is any suitable oxidation catalyst 210. The oxidation catalyst 210 is an exhaust aftertreatment device configured to, for example, reduce emissions by converting carbon monoxide and hydrocarbons into carbon dioxide and water vapor by utilizing oxygen present in the exhaust gas. For the oxidation catalyst 210 to be effective, it must be warmed to or above an activation temperature to “activate” the oxidation catalyst. For example, the oxidation catalyst 210 may be configured such that it must be warmed to at least 215 °C to be activated. The oxidation catalyst 210 is present in the engine compartment 20 in the applications of FIGS. 2, 3, and 4. Downstream of the oxidation catalyst 210 is an exhaust throttle 222. Any suitable number of additional exhaust treatment devices may be included prior to the exhaust outlet 220. Such additional exhaust treatment devices may be included outside of the engine compartment 20, for example. The example of FIG. 4 described herein includes a number of additional exhaust treatment devices within the turbine exhaust conduit 190.

The EGR system 110 further includes a low-pressure (LP) EGR conduit 250. The LP-EGR conduit 250 extends from the turbine exhaust conduit 190 at a location downstream of the oxidation catalyst 210. The LP-EGR conduit 250 extends to the intake conduit 150 downstream of both the compressor 122 and the throttle valve 180 with respect to a direction of airflow through the intake conduit 150. A low-pressure (LP) EGR valve 260 is at, or near, a junction between the turbine exhaust conduit 190 and the LP-EGR valve 260. The LP-EGR valve 260 is any suitable flow control device configured to control flow of exhaust gas from the turbine exhaust conduit 190 to the LP-EGR conduit 250.

The EGR system 110 also includes a controller 310. The controller 310 is configured to open and close the LP-EGR valve 260. For example, the controller 310 is configured to open the LP-EGR valve 260 when the engine 50 is at idle subsequent to a cold start to recirculate exhaust from the turbine 124 through each of the engine 50, the turbine 124, and the oxidation catalyst 210. Recirculating exhaust gas in this manner directs additional heat to the oxidation catalyst 210 to reduce the activation time thereof, which reduces emissions.

The controller 310 is further in cooperation with the turbine 124 to control the restricting vanes 126 thereof. In particular, the controller 310 is configured to open and close the restricting vanes 126 to any suitable degree. At least substantially closing the restricting vanes 126 increases pressure and temperature of exhaust within the turbine and heats the housing 132 of the turbocharger 120. As the exhaust gas flows through the housing 132 of increased temperature, the temperature of the exhaust gas increases further to reduce the activation time of the oxidation catalyst 210. Although the activation temperature of the oxidation catalyst 210 is 215 °C (or about 215 °C), the EGR system 110 is configured to increase the temperature to 250 °C or higher. The controller 310 is further in cooperation with at least the throttle valve 180 and the engine 50 to control operation thereof. The controller 310 may also be in communication with various diagnostic sensors, such as temperature sensors, throughout the EGR system 110 and the vehicle 10 to monitor operation thereof.

With additional referenced to FIG. 3, the EGR system 110 may further include a high-pressure (HP) EGR conduit 270. The HP-EGR conduit 270 is in fluid communication with the engine exhaust conduit 170 at a location upstream of the turbine 124. The HP-EGR conduit 270 extends to the intake conduit 150 at a point downstream of both the compressor 122 and the throttle valve 180. A high-pressure (HP) EGR valve 272 is configured to regulate exhaust flow from the engine 50 to the HP-EGR conduit 270. The HP-EGR conduit 270 merges with the LP-EGR conduit 250 prior to reaching the intake conduit 150. As illustrated in the example of FIG. 2, the HP-EGR conduit 270 is optional. In some applications, the EGR system 110 is configured to operate with the LP-EGR conduit 250 and without the HP-EGR conduit 270.

The controller 310 is configured to close the HP-EGR valve 272 when the LP-EGR valve 260 is open. And the controller 310 is configured to open the HP-EGR valve 272 when the LP-EGR valve 260 is closed. Specifically, the controller 310 is configured to open the LP-EGR valve 260 (and close the HP-EGR valve 272) when the engine 50 is at idle and temperature of the oxidation catalyst 210 is below the activation temperature. The controller 310 is configured to open the HP-EGR valve 272 (and close the LP-EGR valve 260) after the oxidation catalyst 210 is warmed above its activation temperature and the engine is running above idle. The controller 310 is in communication with various sensors 320A, 320B, 320C, 320C, etc., throughout the EGR system 110 to monitor temperature of the fresh air, exhaust gas, the oxidation catalyst 210, etc. The sensors 320A, 320B, 320C, 320C, etc. may be configured as temperature and/or pressure sensors.

The HP-EGR conduit 270 may include an EGR cooler 280. The EGR cooler 280 is any suitable cooling device configured to cool HP exhaust gas flowing through the HP-EGR conduit 270. When temperature of the HP exhaust gas is above a predetermined temperature (such as in response to increased load of the engine 50), the controller 310 is configured to operate an EGR cooler bypass valve 282 to direct the HP exhaust gas through the EGR cooler 280 to reduce the temperature thereof prior to being recirculated through the engine 50. At reduced loads, the controller 310 is configured to operate the EGR cooler bypass valve 282 to direct the HP exhaust gas around the EGR cooler 280 to bypass the EGR cooler 280.

The configuration of FIG. 3 illustrates an example including only the oxidation catalyst 210 present in the turbine exhaust conduit 190. Such a configuration may be used when the engine 50 is configured as a V8 engine. In the configuration of FIG. 4, the turbine exhaust conduit 190 includes the oxidation catalyst 210 in addition to a selective catalytic reduction catalyst 214 and a diesel particulate filter 216, which may be arranged outside of the engine compartment 20. Any suitable urea injector 212 may be arranged, for example, between the oxidation catalyst 210 and the selective catalytic reduction catalyst 214 to further reduce emissions.

The present disclosure further provides for a method of activating an oxidation catalyst during a cold engine start with the engine at idle, particularly during a remote engine start. At cold engine start, the controller 310 is configured to close the HP-EGR conduit 270 by closing the HP-EGR valve 272. And the controller 310 is configured to open the LP-EGR conduit 250 by opening the LP-EGR valve 260. As a result, exhaust from the turbine 124 is directed to the oxidation catalyst 210 to warm it to its activation temperature. To further increase the temperature of the exhaust flowing from the turbine 124, the controller 310 is configured to at least partially close the restricting vanes 126 to trap exhaust gas within the housing 132 as described above. As a result, the temperature of the exhaust gas increases, the temperature of the housing 132 increases, and the temperature of the exhaust gas within the housing 132 also increases. This increased temperature is transferred to the oxidation catalyst 210 to further reduce the time needed to activate oxidation catalyst 210.

The controller 310 is in communication with various sensors of the EGR system 110 to monitor the temperature of the oxidation catalyst 210. When the temperature of the oxidation catalyst 210 reaches the activation temperature and the engine 50 is operating at loads above idle, the controller 310 is configured to close the LP-EGR valve 260 and open the HP-EGR valve 272, which directs exhaust through the HP-EGR conduit 270. In some applications, the controller 310 may be configured to maintain the LP-EGR valve 260 open and maintain the HP-EGR valve 272 closed until the engine 50 operates at up to one-third of its maximum torque.

The EGR system 110 and methods of use of the present disclosure thus lower exhaust emissions (hydrocarbons, NOx, and objectionable fuel aerosol odors, for example) at low engine loads, such as during idling after a cold engine start of a diesel engine. While the LP-EGR valve 260 is open and regulating exhaust flow, the controller 310 closes the HP-EGR valve 272 so that additional exhaust port flow must traverse the turbine 124 and the oxidation catalyst 210 in less time after cold start. When the LP-EGR conduit 250 is used rather than the HP-EGR conduit 270, increased pressure in the engine exhaust conduit 170 (and the engine exhaust manifold 172) can be induced when the controller 310 sets the restricting vanes 126 of the turbine 124 to be more restrictive.

At low engine torque, pressure in the engine exhaust conduit 170 (and the engine exhaust manifold 172) can approach or even exceed the in-cylinder pressure late in the power stroke at the time the exhaust valve 54 opens, thereby relocating the gas expansion temperature drop to take place across the turbine 124 rather than across the exhaust valves 54. This further increases the temperature of exhaust flowing to the turbine 124, which provides hotter exhaust needed to warm the housing 132 before the oxidation catalyst 210 is activated.

Such an increase in cylinder pressure during the exhaust strokes also increases the pumping work of the piston 56 during the exhaust stroke, which is an acceptable tradeoff to provide clean combustion at idle.

The “short route” LP-EGR system of the present disclosure is beneficial for continuously sustaining adequate temperature during extended periods of idle at low load or cool ambient temperatures. Depending on geometry, formulation, and performance of the oxidation catalyst 210, one scenario of the present disclosure is to wait to activate the “short route” LP-EGR system until after initial engine start and until after the oxidation catalyst 210 rises at its front face to an initial temperature at or near 145 °C. At this temperature, the oxidation catalyst 210 oxidizes carbon monoxide, but is not yet warm enough to oxidize hydrocarbons. Activation of the “short route” LP-EGR system is deferred until this light-off threshold temperature is crossed. The “short route” LP-EGR system of the present disclosure is subsequently favored and used to maintain temperature at idle condition until the temperature exiting the oxidation catalyst 210 (supplying the selective catalytic reduction system) reaches its target temperature of 215 °C. This “short route” LP-EGR minimum light-off threshold temperature may be, for example 10 °C or 145 °C.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. An exhaust gas recirculation (EGR) system for an engine comprising:
a turbocharger including a compressor and a turbine;
restricting vanes included with the turbine and movable to regulate flow of exhaust through the turbine;
an intake conduit extending from the compressor to the engine;
a throttle valve along the intake conduit configured to regulate flow of air from the compressor to the engine;
an engine exhaust conduit extending from the engine to the turbine;
a turbine exhaust conduit extending from the turbine to an exhaust outlet;
an oxidation catalyst along the turbine exhaust conduit;
a low-pressure EGR conduit extending from the turbine exhaust conduit downstream of the oxidation catalyst, and extending to the intake conduit downstream of both the compressor and the throttle valve with respect to a direction of airflow through the intake conduit;
a low-pressure EGR valve configured to regulate exhaust flow from the turbine exhaust conduit into the low-pressure EGR conduit;
a high-pressure EGR conduit in fluid communication with the engine exhaust conduit upstream of the turbine the high-pressure EGR conduit extending to the intake conduit downstream of the compressor and the throttle valve;
a high-pressure EGR valve configured to regulate exhaust flow from the engine into the high-pressure EGR conduit; and
a controller configured to control the restricting vanes, the low-pressure EGR valve, and the high-pressure EGR valve,
wherein to heat and activate the oxidation catalyst when the engine is at idle, the controller is configured to close the high-pressure EGR valve, at least substantially close the restricting vanes to increase pressure and temperature of exhaust within the turbine and heat a housing of the turbine, and open the low-pressure EGR valve to recirculate exhaust from the turbine through each of the engine, the turbine, and the oxidation catalyst.

2. The EGR system of claim 1, wherein the engine is a diesel engine.

3. The EGR system of claim 1, further comprising a selective catalytic reduction catalyst and a diesel particulate filter downstream of the oxidation catalyst and upstream of the low-pressure EGR valve with respect to exhaust flow from the turbine exhaust conduit, and a urea injection point between the oxidation catalyst and the selective catalytic reduction catalyst,
wherein the controller is configured to open the low-pressure EGR valve when the engine is at idle to recirculate exhaust from the turbine through the selective catalytic reduction catalyst and the diesel particulate filter.

4. The EGR system of claim 1, further comprising a charge air cooler along the intake conduit upstream of the throttle valve.

5. The EGR system of claim 1, wherein the oxidation catalyst is configured to be engine-mounted within an engine compartment.

6.-7. (canceled)

8. The EGR system of claim 1, wherein the low-pressure EGR conduit merges with the high-pressure EGR conduit.

9. The EGR system of claim 1, wherein the controller is configured to:
close the high-pressure EGR valve when the low-pressure EGR valve is open; and
open the high-pressure EGR valve and close the low-pressure EGR valve after activation of the oxidation catalyst.

10. The EGR system of claim 9, wherein the high-pressure EGR conduit includes an EGR cooler and an EGR cooler bypass valve.

11. The EGR system of claim 1, wherein the controller is configured to open the low-pressure EGR valve and close the high-pressure EGR valve when the engine is operating at up to one-third of maximum torque to recirculate exhaust from the turbine through the engine, the turbine, and the oxidation catalyst.

12. An exhaust gas recirculation (EGR) system for a diesel engine comprising:
a turbocharger including a compressor and a turbine;
restricting vanes included with the turbine and movable to regulate flow of exhaust through the turbine;
an intake conduit extending from the compressor to the diesel engine;
a throttle valve along the intake conduit configured to regulate flow of air from the compressor to the diesel engine;
an engine exhaust conduit extending from the diesel engine to the turbine;
a turbine exhaust conduit extending from the turbine to an exhaust outlet;
an oxidation catalyst along the turbine exhaust conduit;
a low-pressure EGR conduit extending from the turbine exhaust conduit downstream of the oxidation catalyst, and extending to the intake conduit downstream of both the compressor and the throttle valve with respect to a direction of airflow through the intake conduit;
a low-pressure EGR valve configured to regulate exhaust flow from the turbine exhaust conduit into the low-pressure EGR conduit;
a high-pressure EGR conduit in fluid communication with the engine exhaust conduit upstream of the turbine, the high-pressure EGR conduit extending to the intake conduit downstream of the compressor and the throttle valve; and
a high-pressure EGR valve configured to regulate exhaust flow from the diesel engine into the high-pressure EGR conduit;
a controller configured to:
at least substantially close the restricting vanes to increase pressure and temperature of exhaust within the turbine and heat a housing of the turbine, open the low-pressure EGR valve, and close the high-pressure EGR valve when the diesel engine is at idle to recirculate exhaust from the turbine through each of the diesel engine, the turbine, and the oxidation catalyst to heat and activate the oxidation catalyst; and
open the restricting vanes, close the low-pressure EGR valve, and open the high-pressure EGR valve after activation of the oxidation catalyst and in response to increased load on the diesel engine above idle.

13. (canceled)

14. The EGR system of claim 12, wherein the controller is configured to open the low-pressure EGR valve and close a high-pressure EGR valve when the diesel engine is operating at up to one-third of maximum torque to recirculate exhaust from the turbine through the diesel engine, the turbine, and the oxidation catalyst.

15. An exhaust gas recirculation (EGR) method for a diesel engine comprising:
with the diesel engine at idle, and prior to a catalyst reaching an activation temperature:
opening, in response to a first control signal received from a controller, a low-pressure EGR valve configured to regulate exhaust flow from a turbine exhaust conduit of a turbine into a low-pressure EGR conduit extending from the turbine exhaust conduit downstream of the catalyst to an intake conduit downstream of both a compressor and a throttle valve with respect to a direction of airflow through the intake conduit,
closing, in response to a second control signal received from the controller, a high-pressure EGR valve configured to regulate exhaust flow from the diesel engine into a high-pressure EGR conduit that is in fluid communication with an engine exhaust conduit upstream of the turbine, the high-pressure EGR conduit extending to the intake conduit downstream of the compressor and the throttle valve, and
substantially closing restricting vanes of the turbine to increase pressure and temperature of exhaust within the turbine and heat a housing of the turbine in response to instructions from the controller; and
subsequent to the catalyst reaching an activation temperature and in response to increased load on the diesel engine above idle:
closing the low-pressure EGR valve in response to a third control signal received from the controller, and
opening the high-pressure EGR valve in response to a fourth control signal received from the controller.

16. The EGR method of claim 15, further comprising, in response to instructions from the controller, opening the low-pressure EGR valve and closing the high-pressure EGR valve when the diesel engine is operating at up to one-third of maximum torque to recirculate exhaust from the turbine through the diesel engine, the turbine, and the catalyst.

17. (canceled)

18. The EGR method of claim 15, further comprising, in response to an additional control signal from the controller, actuating an EGR cooler bypass valve to direct exhaust gas through an EGR cooler when the high-pressure EGR valve is open in response to the diesel engine operating an increased load above idle.

19. The EGR method of claim 15, wherein the catalyst is an oxidation catalyst, the method further comprising injecting urea into the low-pressure EGR conduit downstream of the oxidation catalyst.

20. The EGR method of claim 15, wherein the catalyst includes an oxidation catalyst and a selective catalytic reduction catalyst, and a diesel particulate filter is included downstream of the selective catalytic reduction catalyst.
